(19) United States
(12) Patent Application Publication
(10) Pub. No.: US 2023/0096153 A1
(43) Pub. Date: Mar. 30, 2023

(54) LITHIUM-ION SECONDARY BATTERY ELECTRODE, LITHIUM-ION SECONDARY BATTERY, AND METHOD FOR MANUFACTURING LITHIUM-ION SECONDARY BATTERY ELECTRODE

(71) Applicant: HONDA MOTOR CO., LTD., (US)

(72) Inventors: Takeshi FUJINO, Saitama (JP); Kazuki SAIMEN, Saitama (JP)

(21) Appl. No.: 17/909,761

(22) PCT Filed: Mar. 12, 2020
(86) PCT No.: PCT/JP2020/010787

§ 371 Date: Sep. 7, 2022

(51) Int. Cl. H01M 10/0562; H01M 10/0525; H01M 4/04; H01M 50/46

(52) U.S. Cl. CPC H01M 10/0562; H01M 10/0525; H01M 4/0404; H01M 50/46; H01M 2004/027

(57) ABSTRACT

Provided are: a lithium-ion secondary battery electrode with which it is possible to realize a battery having high volume energy density and in which capacity reduction due to repeated charging and discharging is suppressed even when the amount of electrolytic solution held by the electrode is low; a lithium-ion secondary battery using said electrode; and a method for manufacturing the lithium-ion secondary battery electrode. A lithium-ion secondary battery electrode in which a highly dielectric oxide solid and the electrolytic solution are positioned in the gaps between active material particles of an electrode mixture layer, wherein: the electrode mixture layer is prepared without using water that is reactive with the highly dielectric oxide solid; and the arrangement of the highly dielectric oxide solid in the electrode mixture layer is specified.

### TECHNICAL FIELD

The present invention relates to a lithium ion secondary battery electrode, a lithium ion secondary battery including such an electrode and a method for manufacturing a lithium ion secondary battery electrode.

### BACKGROUND ART

Conventionally, as secondary batteries having a high energy density, lithium ion secondary batteries are widely used. A lithium ion secondary battery including a liquid as an electrolyte has a structure in which a separator is provided between a positive electrode and a negative electrode and the lithium ion secondary battery is filled with the liquid electrolyte (electrolytic solution).

The lithium ion secondary battery as described above should satisfy a variety of needs depending on the application, and for example, when the application is for automobiles and the like, a volumetric energy density is required to be further increased. In order to cope with this need, a method of increasing the filling density of an electrode active material is provided.

As the method of increasing the filling density of the electrode active material, for example, a method is proposed of controlling the particle diameter and the particle shape of active material particles to minimize air gaps between the active material particles, and packing a large number of active material particles into a certain area to achieve high density filling (see Patent Document 1).

However, when the filling density of the electrode active material is increased, the gap portion between the active material particles within the electrode is reduced, with the result that the amount of electrolytic solution held in the electrode is relatively reduced.

Moreover, in an electrode in which the filling density of an electrode active material is high, an electrode surface pressure is increased by expansion of a negative electrode active material at the time of charge and discharge or the like, with the result that an electrolytic solution provided in the electrode active material is pushed out and thus drying up of the electrolytic solution tends to easily occur.

Then, when in a state where the amount of electrolytic solution held in the electrode is insufficient or in a state where the electrolytic solution is unevenly distributed, charge and discharge are repeated, and resistance is increased by insufficiency of lithium ions to cause variations in potential. Consequently, the solvent constituting the electrolytic solution is easily decomposed, a nonconductive film is formed on the electrode to gradually increase its internal resistance and thus the capacity is lowered.

Under the circumstances as described above, a lithium ion secondary battery in which the capacity is not easily lowered by the repetition of charge and discharge has not been fully realized.

Patent Document 1: Japanese Unexamined Patent Application, Publication No. 2004-192846

### DISCLOSURE OF THE INVENTION

### Problems to be Solved by the Invention

The present invention has been made in view of the background described above, and an object of the present invention is to provide: a lithium ion secondary battery electrode capable of realizing a battery in which, even when a volumetric energy density is high and the amount of electrolytic solution held in the electrode is small, a decrease in capacity caused by the repetition of charge and discharge is suppressed; a lithium ion secondary battery using the electrode; and a method for manufacturing a lithium ion secondary battery electrode.

### Means for Solving the Problems

The present inventors found that by providing not only an electrolytic solution but also high dielectric solid particles in a lithium ion secondary battery electrode, it is possible to prevent the electrolytic solution in the electrode from being unevenly distributed and to enhance ion conductivity, and thus an increase in resistance within the battery caused by the repetition of charge and discharge can be suppressed, and have proposed, in Japanese Patent Application No. 2018-100590, a lithium ion secondary battery electrode in which a high dielectric oxide solid and an electrolytic solution are disposed in the gaps of active material particles in the electrode material mixture layer.

The present inventors have further conducted a study based on the findings described above to find that depending on the type of high dielectric oxide solid, the surface of solid particles is degraded by water contained in a slurry for producing the electrode material mixture layer to decrease activity, and thus the effect of providing both the electrolytic solution and the high dielectric oxide solid particles is lowered.

For example, when Li₇La₃Zr₂O₁₂ (LLZO) which is a high dielectric oxide solid is fed to a water-based slurry, the high dielectric oxide solid reacts with water on the surface of particles to elute Li, and thus LiOH is formed. Hence, interaction with an electrolytic solution is reduced to decrease a ratio of improvement in ion conductivity in the electrolytic solution, and thus the effect of suppressing an increase in resistance is lowered. Moreover, since the high dielectric oxide solid is easily adhered to the surface of a negative electrode active material such as graphite particles, dispersibility into the gaps of electrode active material particles is lowered, and the surface of the negative electrode active material is further coated, with the result that a charge/discharge reaction is inhibited to reduce the contribution to the reduction of an increase in resistance.

On the other hand, a conventional method of producing an electrode using, instead of the water-based slurry, a non-aqueous organic solvent such as N-methyl-2-pyrrolidone (NMP) can be considered. However, since the LLZO reacts with polyvinylidene fluoride (PVDF) serving as a binder, the slurry is formed into gel, and thus it is difficult to apply it to a current collector. In terms of manufacturing costs and battery performance, it is desirable to apply a water-based slurry method using a rubber-based binder such as styrene butadiene rubber (SBR).

The present inventors have further conducted a study on the arrangement of the high dielectric oxide solid in the electrode material mixture layer. Consequently, it has been found that in the lithium ion secondary battery electrode, as compared to the high dielectric oxide solid arranged in the current collector side, the high dielectric oxide solid arranged in the separator side has an effect of improving the performance of the battery.

In particular, in a case where the high dielectric oxide solid having Li ion conductivity is arranged on the surface layer in the separator side of the electrode material mixture layer, when the concentration of Li in the electrolytic solution is decreased in rapid charge, Li within the high dielectric oxide solid moves toward the surface of the high dielectric oxide solid in order to compensate insufficiency of the Li concentration in the electrolytic solution, with the result that a charge reaction on the separator side is restricted. Here, on the surface layer in the separator side of the electrode material mixture layer, the high dielectric oxide solid particles are sandwiched between the electrode active material, and thus it is possible to secure a path for the electrolytic solution to the current collection foil side. Consequently, it has been found that while the charge reaction in the separator side is being suppressed, the supply of the electrolytic solution to the current collection foil side is ensured, and variations in potential in the direction of thickness of the electrode material mixture layer are suppressed, with the result that this contributes to prevention of electrodeposition of the negative electrode active material in contact with the separator side and to the enhancement of cycle durability.

Based on these new findings, the present inventors considered that by producing an electrode material mixture layer without use of water which is reactive with a high dielectric oxide solid, and arranging the high dielectric oxide solid in the electrode material mixture layer in a specific position, it is possible to realize, at a higher level, a battery in which, even when a volumetric energy density is high and the amount of electrolytic solution held in the electrode is small, a decrease in capacity caused by the repetition of charge and discharge is suppressed, with the result that the present invention has been completed.

Specifically, the present invention provides a lithium ion secondary battery electrode including an electrolytic solution. The lithium ion secondary battery electrode includes a current collector; and an electrode material mixture layer stacked on the current collector, the electrode material mixture layer including an electrode active material and a first high dielectric oxide solid. In the electrode material mixture layer, the first high dielectric oxide solid is arranged to have a concentration gradient that is continuously or stepwise reduced from a surface opposite to the current collector toward the current collector in the direction of thickness of the electrode material mixture layer.

The first high dielectric oxide solid may be arranged in gaps of the electrode active material.

In the electrode material mixture layer, the first high dielectric oxide solid may be arranged in a region at one half or less of the thickness in the direction of the thickness from the surface opposite to the current collector.

The first high dielectric oxide solid may be an oxide solid electrolyte.

The lithium ion secondary battery electrode may be a negative electrode.

The first high dielectric oxide solid may be a reduction decomposition-resistant lithium ion conductive solid electrolyte.

The reduction decomposition-resistant lithium ion conductive solid electrolyte may have a reduction decomposition potential that is lower than a Li/Li⁺ equilibrium potential by 1.5 V (1.5 V vs Li/Li⁺) or less.

The reduction decomposition-resistant lithium ion conductive solid electrolyte may be at least one or more types selected from the group consisting of Li₇La₃Zr₂O₁₂, Li₅La₃Ta₂O₁₂, LiNbO₃, Li₃PO₄ and Li_{2.9}PO_{3.3}N_{0.46}.

The electrode material mixture layer may further include a second high dielectric oxide solid.

The second high dielectric oxide solid may be arranged in the gaps of the electrode active material.

The second high dielectric oxide solid may be arranged substantially uniformly over the entirety of the electrode material mixture layer.

Another aspect of the present invention provides a lithium ion secondary battery including: a positive electrode; a negative electrode; a separator that electrically insulates the positive electrode and the negative electrode; and an electrolytic solution, and the negative electrode is the lithium ion secondary battery electrode described above.

The lithium ion secondary battery may include a container that houses the positive electrode, the negative electrode, the separator and the electrolytic solution, and the separator may be in contact with the electrolytic solution stored in the container.

Yet another aspect of the present invention provides a method for manufacturing a lithium ion secondary battery electrode including a current collector and an electrode material mixture layer stacked on the current collector. The method includes: an electrode paste preparation step of preparing an electrode paste including an electrode active material and water; an electrode material mixture precursor layer formation step of applying the electrode paste on the current collector and drying the water to obtain an electrode material mixture precursor layer; a high dielectric oxide dispersion liquid preparation step of preparing a high dielectric oxide dispersion liquid including a first high dielectric oxide solid and an organic solvent; an electrode material mixture layer formation step of bringing the high dielectric oxide dispersion liquid into contact with a surface opposite to a surface of the current collector side of the electrode material mixture precursor layer and drying the organic solvent to obtain the electrode material mixture layer; and a press step of pressing the electrode material mixture layer to obtain the lithium ion secondary battery electrode.

A method for the bringing of the high dielectric oxide dispersion liquid into contact in the electrode material mixture layer formation step may be at least one type selected from the group consisting of dropping, applying, spraying and impregnating.

In the electrode material mixture layer formation step, the first high dielectric oxide solid may be arranged to have a concentration gradient that is continuously or stepwise reduced from a surface opposite to the current collector toward the current collector in the direction of thickness of the electrode material mixture layer.

The electrode paste may further include a second high dielectric oxide solid.

The lithium ion secondary battery electrode may be a negative electrode.

### BRIEF DESCRIPTION OF THE DRAWINGS

FIG. 1 is a cross-sectional view showing an embodiment of the lithium ion secondary battery of the present invention.

### PREFERRED MODE FOR CARRYING OUT THE INVENTION

An embodiment of the present invention will then be described in more detail with reference to drawings.

### <Lithium Ion Secondary Battery Electrode>

The lithium ion secondary battery electrode of the present invention includes an electrolytic solution, a current collector and an electrode material mixture layer stacked on the current collector, and the electrode material mixture layer includes an electrode active material and a first high dielectric oxide solid. In the electrode material mixture layer, the first high dielectric oxide solid is arranged to have a concentration gradient that is continuously or stepwise reduced from a surface opposite to the current collector toward the current collector in the direction of thickness of the electrode material mixture layer.

Although the lithium ion secondary battery electrode of the present invention may be either a lithium ion secondary battery positive electrode or a lithium ion secondary battery negative electrode, when the lithium ion secondary battery electrode is applied to the negative electrode in order to cope with expansion and contraction of a negative electrode active material at the time of charge and discharge and to suppress the formation of a film caused by lithium, it is possible to more receive the effect of the present invention.

### [Current Collector]

The current collector in the lithium ion secondary battery electrode of the present invention is not particularly limited, and a known current collector used in a lithium ion secondary battery can be used.

Examples of the material of a negative electrode current collector can include SUS, Ni, Cu, Ti, Al, calcined carbon, a conductive polymer, conductive glass, an Al-Cd alloy and the like. Examples of the material of a positive electrode current collector can include metal materials such as SUS, Ni, Cr, Au, Pt, Al, Fe, Ti, Zn and Cu and the like.

Examples of the shape of the current collector can include a foil shape, a plate shape, a mesh shape and the like. The thickness thereof is not particularly limited, and though examples of the thickness can include 1 to 20 μm, the thickness can be selected as necessary.

### [Electrode Material Mixture Layer]

In the lithium ion secondary battery electrode of the present invention, the electrode material mixture layer includes the electrode active material and the first high dielectric oxide solid as essential components. The electrode material mixture layer is preferably formed on at least one surface of the current collector, and may be formed on both surfaces. The electrode material mixture layer can be selected as necessary according to the type and structure of the target lithium ion secondary battery.

As long as the electrode material mixture layer includes, as essential components, the electrode active material and the first high dielectric oxide solid which are constituent elements of the present invention, other constituent components may be arbitrarily included. Examples of the arbitrary components can include known components such as a conductive aid and a binder.

### [Electrode Active Material]

The electrode active material included in the lithium ion secondary battery electrode of the present invention is not particularly limited as long as the electrode active material can store and release lithium ions, and a known material serving as an electrode active material for a lithium ion secondary battery can be applied.

### (Negative Electrode Active Material)

When the lithium ion secondary battery electrode of the present invention is a lithium ion secondary battery negative electrode, examples of the negative electrode active material can include metallic lithium, a lithium alloy, metal oxide, metal sulfide, metal nitride, silicon oxide, silicon, carbon materials such as graphite and the like. As the negative electrode active material, a negative electrode active material which shows a low potential as compared with the positive electrode is preferably selected from materials capable of forming an electrode.

### (Positive Electrode Active Material)

When the lithium ion secondary battery electrode of the present invention is a lithium ion secondary battery positive electrode, examples of a positive electrode active material layer can include LiCoO₂, LiCoO₄, LiMn₂O₄, LiNiO₂, LiFePO₄, lithium sulfide, sulfur and the like. As the positive electrode active material, a positive electrode active material which shows a noble potential as compared with the negative electrode is preferably selected from materials capable of forming an electrode.

### [First High Dielectric Oxide Solid]

The first high dielectric oxide solid included in the lithium ion secondary battery electrode of the present invention is not particularly limited as long as the first high dielectric oxide solid is a high dielectric oxide. In general, the permittivity of solid particles crushed from a crystalline state is changed from the original crystalline state, and thus the dielectric constant is lowered. Hence, as the first high dielectric oxide solid used in the present invention, powder crushed in a state where a high dielectric state can be maintained as much as possible is preferably used.

The powder relative permittivity of the first high dielectric oxide solid used in the present invention is preferably 10 or more, and further preferably 20 or more. When the powder relative permittivity is 10 or more, even if the charge/discharge cycle is repeated, an increase in internal resistance can be suppressed, with the result that it is possible to fully realize a lithium ion secondary battery having excellent durability for the charge/discharge cycle.

Here, the “powder relative permittivity” in the present specification refers to a value which is determined as follows.

### (Method of Measuring Powder Relative Permittivity)

Powder is introduced into a 38 mm diameter (R) tablet molding machine for measurement, and is compressed using a hydraulic press such that the thickness (d) is 1 to 2 mm, with the result that compacted powder is formed. The molding conditions of the compacted powder are set such that the relative density of the powder (D_{powder}=compacted powder weight density/true specific gravity of the dielectric×100 is at least 40% or more and is preferably 50%, the capacitance Cₜₒₜₐₗ of the molded product is measured at 1 kHz at 25° C. by an automatic balancing bridge method using an LCR meter and thus a compacted powder relative permittivity ϵₜₒₜₐₗ is calculated. In order to determine the permittivity ϵ_{powder} of an actual volume portion from the compacted powder relative permittivity obtained, on assumption that the vacuum permittivity ϵₒ is 9.854×10⁻¹² and the permittivity of air ϵₐᵢ, is 1, the following formulae (1) to (3) are used to calculate the “powder relative permittivity ϵ_{powder}”. Contact area A between compacted powder and electrode=(R/2)²π (1)

Cₜₒₜₐₗ=ϵₜₒₜₐₗ×ϵₒ×(A/d) (2)

ϵₜₒₜₐₗ=ϵ_{powder}×D_{powder}+ϵₐᵢ×(1−D_{powder}) (3)

Although the particle diameter of the first high dielectric oxide solid is not particularly limited, in terms of enhancing the electrode volume filling density of the electrode active material, the particle diameter is preferably one fifth or less of the particle diameter of the electrode active material, and more preferably in a range of 0.02 to 3 μm. When the particle diameter of the high dielectric oxide solid is 0.02 μm or less, the high dielectric property cannot be maintained, and thus the effect of enhancing a capacity maintenance rate is unlikely to be obtained. When the particle diameter is 3 μm or more, it is difficult to effectively arrange the high dielectric oxide solid between the active material particles of the electrode material mixture layer. In order to provide electronic conductivity to the high dielectric oxide solid, it is preferable to perform coating using carbon which is known by a method disclosed in Japanese Patent Application No. 2018-99451. In this way, it is possible to maintain output performance without inhibiting the electronic conductivity of an electrode member, that is, without increasing the resistance of the battery.

### (Arrangement of First High Dielectric Oxide Solid)

In the electrode material mixture layer of the lithium ion secondary battery electrode of the present invention, the first high dielectric oxide solid is arranged to have a concentration gradient that is continuously or stepwise reduced from the surface opposite to the current collector toward the current collector in the direction of thickness of the electrode material mixture layer.

In the electrode material mixture layer, the first high dielectric oxide solid is arranged such that the concentration is high in the separator side, not in the current collector side, and thus it is possible to improve the performance of the lithium ion secondary battery in a more satisfactory manner by using the electrode obtained.

Specifically, when Li ions are reduced by rapid charge or the like and thus the concentration of Li in the electrolytic solution is decreased, a charge reaction for Li ions in the electrolytic solution is inhibited by the presence of the high dielectric oxide solid. When Li ions in the electrolytic solution are increased by discharge, the high dielectric oxide solid prevents association of ions in a lithium salt, and thus a discharge reaction is accelerated.

In the lithium ion secondary battery electrode of the present invention, the high dielectric oxide solid particles are present around the surface layer in the separator side of the electrode material mixture layer, and thus a path for the electrolytic solution can be secured, with the result that variations in potential in the direction of thickness of the electrode material mixture layer are suppressed, electrodeposition is suppressed and the cycle durability of the lithium ion secondary battery can be enhanced.

In the electrode material mixture layer of the lithium ion secondary battery electrode of the present invention, the first high dielectric oxide solid is more preferably arranged in a region at one half or less of the thickness from the surface opposite to the current collector in the direction of the thickness. The first high dielectric oxide solid is arranged in the region at one half or less of the thickness, and thus variations in potential in the direction of the electrode can be sufficiently suppressed without the dielectric oxide particles being arranged to be inclined over the direction of the thickness.

Furthermore, in the electrode material mixture layer of the lithium ion secondary battery electrode of the present invention, the first high dielectric oxide solid is preferably arranged in the gaps of the electrode active material. The gaps formed between the particles of the electrode active material can be controlled by the filling rate of the electrode active material, and are related to the density of the electrode material mixture layer. In the gaps of the particles of the electrode active material, a resin binder serving as a binder, a carbon material serving as a conductive aid for providing electronic conductivity and the like may be arranged.

In the gaps of the particles of the electrode active material, the first high dielectric oxide solid is arranged, and thus the lithium ion secondary battery electrode of the present invention can suppress a decrease in the diffusion of lithium ions within the electrode to suppress an increase in resistance, with the result that it is possible to realize the electrode having a high filling density of the electrode active material. Consequently, even when the volumetric energy density is high and the electrode holds a small amount of electrolytic solution, it is possible to realize the lithium ion secondary battery which suppresses a decrease in capacity caused by the repetition of the charge and discharge.

In the gaps of the particles of the electrode active material, the first high dielectric oxide solid is arranged, and thus in the lithium ion secondary battery electrode of the present invention, the permeability of the electrolytic solution is enhanced. Consequently, uniformity of the electrolytic solution held in the electrode is enhanced. It is also possible to reduce the impregnation time of the electrolytic solution into the electrode and to enhance the productivity.

Furthermore, in the gaps of the particles of the electrode active material, the first high dielectric oxide solid is arranged, and thus in the lithium ion secondary battery electrode of the present invention, by the dielectric effect, it is possible to suppress association of lithium ions with anions. Consequently, for example, even when the electrolytic solution containing a high concentration of lithium salt is used, it is possible to achieve the effect of reducing the resistance at the time of discharge.

### (Type of First High Dielectric Oxide Solid)

Although the first high dielectric oxide solid is not particularly limited as long as the first high dielectric oxide solid is a high dielectric oxide, the high dielectric oxide solid is preferably an oxide solid electrolyte. When the first high dielectric oxide solid is the oxide solid electrolyte, an inexpensive crystal can be produced, and the first high dielectric oxide solid is excellent in electrochemical oxidation resistance and reduction resistance. Since the true specific gravity of the oxide solid electrolyte is low, it is possible to suppress an increase in the weight of the electrode.

Furthermore, the first high dielectric oxide solid is preferably an oxide solid electrolyte which has lithium ion conductivity. When the first high dielectric oxide solid is a high dielectric oxide solid electrolyte having lithium ion conductivity, the output of the obtained lithium ion secondary battery at low temperature can be more enhanced. It is also possible to relatively inexpensively produce the lithium ion secondary battery electrode which is excellent in electrochemical oxidation resistance and reduction resistance.

Examples of the high dielectric oxide solid can include: a composite metal oxide having a perovskite crystal structure such as BaTi₃, BaₓSr₁₋ₓTiO₄ (X=0.4 to 0.8), BaZrₓTi₁₋ₓO₄ (X=0.2 to 0.5) or KNbO₃; and a composite metal oxide having a layered perovskite crystal structure containing bismuth such as SrBi₂Ta₂O₀ or SrBi₂Nb₂O₀.

As the high dielectric oxide solid having lithium ion conductivity, for example, a composite metal oxide can be used which is represented by a formula of Li_{7-y}La₃₋ₓAxZr_{2-y}MyO₁₂ (in the formula, A is one type of metal selected from the group consisting of Y, Nd, Sm and Gd, x is in a range of 0≤x≤3, M is Nb or Ta and y is in a range of 0≤y<2) and has a garnet structure.

Examples also can include LiₓNy_{y}O₃, a composite oxide having an ilmenite structure of LiₓTa_{y}O₃ (x/y=0.9 to 1.1), Li₃PO₄, LiₓPO_{y}N_{z} (x=2y+3z−5, LIPON), Li₇La₃Zr₂O₁₂ (LLZO), Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5} (PO₄)₃(LAGP), Li_{1+x+y}AlₓTi₂₋ₓSi_{y}P_{3-y}O₁₂, Li_{1+x+y}Alₓ(Ti, Ge)₂₋ₓSi_{y}P_{3-y}O₁₂, Li₄₋₂ₓZnₓGeO₄ LISICON) and the like.

More specifically, examples can include Li₇La₃Zr₂O₁₂, Li₅La₃Ta₂O₁₂, Li_{2.9}PO_{3.3}N_{0.46}, LiNbO₃, Li₃PO₄ and the like.

As described above, although the lithium ion secondary battery electrode of the present invention may be either a lithium ion secondary battery positive electrode or a lithium ion secondary battery negative electrode, when the lithium ion secondary battery electrode is applied to the negative electrode in order to suppress the formation of an SEI film on the negative electrode at the time of charge and discharge, it is possible to more receive the effect of the present invention.

When the lithium ion secondary battery electrode of the present invention is the negative electrode, the high dielectric oxide solid is preferably a reduction decomposition-resistant lithium ion conductive solid electrolyte.

When the electrode material mixture layer of the negative electrode includes the reduction decomposition-resistant lithium ion conductive solid electrolyte, the reduction decomposition of the high dielectric oxide solid can be suppressed, and thus it is possible to obtain more excellent durability for the charge/discharge cycle.

The reduction decomposition-resistant lithium ion conductive solid electrolyte preferably has a reduction decomposition potential that is lower than a Li/Li⁺ equilibrium potential by 1.5 V (1.5 V vs Li/Li⁺) or less.

When the reduction decomposition potential of the reduction decomposition-resistant lithium ion conductive solid electrolyte is higher than the Li/Li⁺ equilibrium potential by 1.5 V or more, a constituent metal element is eluted by reduction decomposition at the time of charge, and lithium ion conductivity is lowered by a structural change. When the reduction decomposition-resistant lithium ion conductive solid electrolyte is subjected to reduction decomposition, charge is consumed for the reduction decomposition, and thus charge is unlikely to be performed in the active material, with the result that the usage potential range of the lithium ion secondary battery is changed to lower the capacity and durability deteriorates significantly during the charge/discharge cycle.

The reduction decomposition-resistant lithium ion conductive solid electrolyte is preferably at least one or more types selected from the group consisting of LLZO (Li₇La₃ZrO₂O₁₂), LLTO (Li₅La₃Ta₂O₁₂), LiNbO₃, lithium phosphate Li₃PO₄ and LIPON(Li_{2.9}PO_{3.3}N_{0.46}. Among them, since the oxidation-reduction potential of Li is close to the oxidation-reduction potential of Li in the negative electrode active material such as graphite or hard carbon, the LLZO is particularly preferable.

When the lithium ion secondary battery electrode of the present invention is the positive electrode, the high dielectric oxide solid is preferably an oxidation decomposition-resistant lithium ion conductive solid electrolyte.

When the electrode material mixture layer of the positive electrode includes the oxidation decomposition-resistant lithium ion conductive solid electrolyte, the oxidation decomposition of the high dielectric oxide solid can be suppressed, and thus it is possible to obtain more excellent durability for the charge/discharge cycle.

The oxidation decomposition-resistant lithium ion conductive solid electrolyte preferably has an oxidation decomposition potential that is 4.5 V (4.5 V vs Li/Li⁺) or higher than the Li/Li⁺ equilibrium potential.

When the oxidation decomposition potential of the oxidation decomposition-resistant lithium ion conductive solid electrolyte is less than 4.5 V with respect to the Li/Li⁺ equilibrium potential, a constituent metal element is eluted by oxidation decomposition at the time of charge, and lithium ion conductivity is lowered by a structural change. When the oxidation decomposition-resistant lithium ion conductive solid electrolyte is subjected to oxidation decomposition, charge is consumed for the oxidation decomposition, and thus charge is unlikely to be performed in the active material, with the result that the usage potential range of the lithium ion secondary battery is changed to lower the capacity and durability deteriorates significantly during the charge/discharge cycle.

As the oxidation decomposition-resistant lithium ion conductive solid electrolyte, oxide glass ceramics are preferable, and for example, at least one type of Li_{1.6}Al_{0.6}Ti_{1.4}(PO₄)₃ and Li_{1+x+y}(Al, Ga)ₓ(Ti, Ge)₂₋ₓSi_{y}P_{3-y}O₁₂ (0≤x≤1, 0≤y≤1).

Among them, LATP (Li_{1.6}Al_{0.6}Ti_{1.4}(PO₄)₃), LAGP (Li_{1.5}Al_{0.5}Ge_{1.5}(PO₄)₃) or Li_{1+x+y}Alₓ(Ti, Ge)₂₋ₓSi_{y}P_{3-y}O₁₂ (0≤x≤1, 0≤y≤1) is particularly preferable.

### (Amount of First High Dielectric Oxide Solid Mixed)

When the lithium ion secondary battery electrode of the present invention is the negative electrode, the amount of first high dielectric oxide solid mixed in the electrode material mixture layer with respect to the total mass of the electrode material mixture layer is preferably in a range of 0.1 to 5% by mass, and further preferably in a range of 0.2 to 3% by mass. The amount is particularly preferably in a range of 0.3 to 2 by mass, and when the amount is in the range described above, the influence of an increase in the volume and an increase in the weight of the electrode member caused by the mixing is small and a decrease in capacity caused by charge and discharge can be minimized.

### [Second High Dielectric Oxide Solid]

The lithium ion secondary battery electrode of the present invention may arbitrarily include, in addition to the first high dielectric oxide solid serving as the essential constituent component, a second high dielectric oxide solid. Although the second high dielectric oxide solid is not particularly limited as long as the second high dielectric oxide solid is different from the first high dielectric oxide solid, lithium triphosphate Li₃PO₄ and lithium niobate LiNbO₃ can be used.

### (Arrangement of Second High Dielectric Oxide Solid)

When the electrode material mixture layer of the lithium ion secondary battery electrode of the present invention incudes the second high dielectric oxide solid, the second high dielectric oxide solid is preferably arranged in the gaps of the electrode active material.

Furthermore, in the electrode material mixture layer of the lithium ion secondary battery electrode of the present invention, as in the first high dielectric oxide solid, the second high dielectric oxide solid is preferably arranged in the gaps of the electrode active material. The second high dielectric oxide solid is arranged in the gaps of the electrode active material, and thus even when a volumetric energy density is high and the amount of electrolytic solution held in the electrode is small, it is possible to realize the lithium ion secondary battery which suppresses a decrease in capacity and an increase in resistance caused by the repetition of the charge and discharge. It is also possible to enhance uniformity of the electrolytic solution held in the electrode and reduce the impregnation time of the electrolytic solution into the electrode, with the result that the productivity can be enhanced.

When the electrode material mixture layer of the lithium ion secondary battery electrode of the present invention incudes the second high dielectric oxide solid, the second high dielectric oxide solid is preferably arranged substantially uniformly over the electrode material mixture layer. Specifically, in the electrode material mixture layer in the lithium ion secondary battery electrode of the present invention, the second high dielectric oxide solid is present substantially uniformly over the entire electrode material mixture layer of the second high dielectric oxide solid, and the first high dielectric oxide solid is arranged to have a concentration gradient that is continuously or stepwise reduced from the surface opposite to the current collector toward the current collector in the direction of thickness of the electrode material mixture layer.

Preferably, when the electrode material mixture layer includes the second high dielectric oxide solid, the second high dielectric oxide solid is previously mixed in an electrode paste for forming the electrode material mixture layer, and the electrode paste is used to produce the electrode material mixture layer. The second high dielectric oxide solid is previously mixed in the electrode paste, and thus in the electrode material mixture layer formed, it is possible to easily arrange the second high dielectric oxide solid between the particles of the electrode active material and it is easy to arrange the second high dielectric oxide solid uniformly over the entire electrode material mixture layer.

As the second high dielectric oxide solid, the same material as the first high dielectric oxide solid described above can be used. However, when the second high dielectric oxide solid is previously mixed in the electrode paste, a material which is less reactive with the solvent of the electrode paste than the first high dielectric oxide solid is preferably used. When a high dielectric oxide solid which is reactive with the solvent of the electrode paste is used, it is difficult to maximize the effect on the added amount.

### <Lithium Ion Secondary Battery>

The lithium ion secondary battery of the present invention includes the positive electrode, the negative electrode, the separator which electrically insulates the positive electrode and the negative electrode and the electrolytic solution, and the lithium ion secondary battery electrode of the present invention described above is applied as the negative electrode to the lithium ion secondary battery.

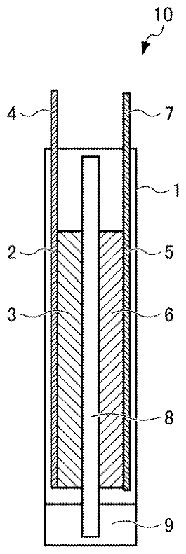

An embodiment of the lithium ion secondary battery of the present invention is shown in FIG. 1

The lithium ion secondary battery 1 of the embodiment shown in FIG. 1 includes: a positive electrode 4 which has a positive electrode material mixture layer 3 formed on a positive electrode current collector 2; a negative electrode 7 which has a negative electrode material mixture layer 6 formed on a negative electrode current collector 5; a separator 8 which electrically insulates the positive electrode 4 and the negative electrode 7; an electrolytic solution 9; and a container 10 which houses the positive electrode 4, the negative electrode 7, the separator 8 and the electrolytic solution 9.

Within the container 10, the positive electrode material mixture layer 3 and the negative electrode material mixture layer 6 are opposite each other through the separator 8, and the electrolytic solution 9 is stored below the positive electrode material mixture layer 3 and the negative electrode material mixture layer 6. An end portion of the separator 8 is immersed in the electrolytic solution 9.

In the lithium ion secondary battery shown in FIG. 1, the positive electrode material mixture layer 3 includes the positive electrode active material, and the negative electrode material mixture layer 6 includes the negative electrode active material. The negative electrode material mixture layer 6 also includes the first high dielectric oxide solid. The negative electrode material mixture layer 6 includes the first high dielectric oxide solid, and thus it is possible to reduce variations in charge to enhance a rapid charge capacity and durability.

### [Electrolytic Solution]

As the electrolytic solution used in the lithium ion secondary battery of the present invention, an electrolytic solution formed of a non-aqueous solvent and an electrolyte can be used, and the concentration of the electrolyte is preferably in a range of 0.1 to 10 mol/L.

### (Non-Aqueous Solvent)

Examples of the non-aqueous solvent can include non-protonic solvents such as carbonates, esters, ethers, nitriles, sulfones and lactones. Specific examples thereof can include ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetratetraxane, 1,3-dioxolane, diethylene glycol dimethyl ether, ethylene glycol dimethyl ether, acetonitrile (AN), propionitrile, nitromethane, N,N-dimethylformamide (DMF), dimethylsulfoxide, sulfolane, γ-butyrolactone and the like.

### (Electrolyte)

Examples of the electrolyte can include LiPF₄, LiBF₄, LiClO₄, LiN(SO₂CF₃), LiN(SO₂C₂F₅)₂, LiCF₃SO₃, LiC₄F₃SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (x=2y+3z−5, LiPON), Li₇La₃Zr₂O₁₂ (LLZO), Li₃ₓLa_{2/3-x}TiO₃ (LLTO), Li₁₊ₓAlₓTi₂₋ₓ PO₄)₃ (0≤x≤1, LATP), Li_{1.5}Al_{0.5}Ge_{1.5}(PO₄)₃(LAGP), Li_{1+x+y}AlₓTiₓ₋ₓSi_{y}P_{3-y}O₁₂, Li_{1+x+y}Alₓ (Ti, Ge)₂₋ₓSi_{y}P_{3-y}O₁₂, Li₄₋₂ₓZnₓGeO₄ (LISION) and the like, and LiPF₆, LiBF₄ or a mixture thereof is preferable.

Examples of the electrolytic solution can include: an electrolytic solution including an ionic liquid; and an electrolytic solution including a polymer having, in an ionic liquid, an aliphatic chain such as polyethylene oxide (PEO) or polyvinylidene fluoride (PVdF) copolymer. The electrolytic solution including the ionic liquid can flexibly cover the surface of the positive electrode active material or the negative electrode active material.

In the lithium ion secondary battery 1 of the embodiment shown in FIG. 1, the electrolytic solution 9 fills the positive electrode material mixture layer 3, the gaps of the negative electrode material mixture layer 6 and the holes of the separator 8, and is stored in the bottom portion of the container 10. In the present embodiment, the separator 8 is in contact with the electrolytic solution 9 stored in the container 10, and thus when the electrolytic solution 9 is consumed, the positive electrode material mixture layer 3 and the negative electrode material mixture layer 6 can be replenished with the electrolytic solution 9 through the separator 8.

The mass of the electrolytic solution 9 stored in the bottom portion of the container 10 is preferably in a range of 3 to 25% by mass with respect to the mass of the electrolytic solution 9 filling the positive electrode material mixture layer 3, the gaps of the negative electrode material mixture layer 6 and the holes of the separator 8.

### <Method for Manufacturing Lithium Ion Secondary Battery Electrode>

A method for manufacturing a lithium ion secondary battery electrode according to the present invention is a method for manufacturing a lithium ion secondary battery electrode including a current collector and an electrode material mixture layer stacked on the current collector, and includes an electrode paste preparation step, an electrode material mixture precursor layer formation step, a high dielectric oxide solid dispersion liquid preparation step, an electrode material mixture layer formation step and a press step.

### [Electrode Paste Preparation Step]

The electrode paste preparation step is a step of preparing an electrode paste including an electrode active material and water. In the manufacturing of the electrode material mixture layer of the lithium ion secondary battery electrode, in terms of manufacturing costs, environmental load and battery performance, a water-based slurry method is preferably applied. In the method for manufacturing a lithium ion secondary battery electrode according to the present invention, the electrode paste for forming the electrode material mixture layer is water-based, and thus it is possible to satisfy the needs described above.

### (Electrode Active Material)

Although the electrode active material used in the electrode paste preparation step is not particularly limited, the electrode active material can be preferably applied to the lithium ion secondary battery electrode of the present invention. The electrode active material which can be applied to each of the positive electrode and the negative electrode can be selected as necessary to be used.

### (Preparation Conditions)

The concentration of the electrode active material in the electrode paste is not particularly limited, and can be selected as necessary according to conditions in the electrode material mixture precursor layer formation step to be performed later. A method of preparing the electrode paste is not particularly limited, and a known method can be applied.

### (Mixing of Second High Dielectric Oxide Solid)

In the electrode paste preparation step of the present invention, a second high dielectric oxide solid which is different from a first high dielectric oxide solid used in the high dielectric oxide solid dispersion liquid preparation step described later may be mixed in the electrode paste together with the electrode active material.

The second high dielectric oxide solid is previously mixed in the electrode paste, and thus in the electrode material mixture layer which is formed, it is possible to easily arrange the second high dielectric oxide solid between the particles of the electrode active material and to arrange the second high dielectric oxide solid substantially uniformly over the entire electrode material mixture layer.

In this way, even when the volumetric energy density is high and the electrode holds a small amount of electrolytic solution, it is possible to realize the lithium ion secondary battery which suppresses a decrease in capacity caused by the repetition of the charge and discharge. Uniformity of the electrolytic solution held in the electrode is achieved, and the impregnation time of the electrolytic solution into the electrode can be reduced, with the result that the productivity can be enhanced.

Although the second high dielectric oxide solid is not particularly limited, the second high dielectric oxide solid can be preferably applied to the lithium ion secondary battery electrode of the present invention. In other words, the same material as the first high dielectric oxide solid described above can be used.

In particular, a second high dielectric oxide solid which is less reactive with water serving as the solvent of the electrode paste is preferable. When a solid which is reactive with the water of the electrode paste is used as the second high dielectric oxide solid, the surface of solid particles deteriorates to decrease activity, and thus it is difficult to maximize the effect on the added amount.

### (Other Components)

As long as the electrode paste includes the electrode active material and water as essential components, other constituent components may be arbitrarily included. Examples of the arbitrary components can include known components such as the second high dielectric oxide solid described above, a conductive aid and a binder.

### [Electrode Material Mixture Precursor Layer Formation Step]

The electrode material mixture precursor layer formation step is a step of applying, on the current collector, the electrode paste prepared in the electrode paste preparation step and drying the water included in the electrode paste to obtain an electrode material mixture precursor layer.

The method of the applying is not particularly limited, and a known method can be applied. Examples thereof can include roller coating using an applicator roll or the like, screen coating, blade coating, spin coating, bar coating and the like.

A method of applying the electrode paste and thereafter drying the water included in the electrode paste is not particularly limited, and a known method can be applied.

Drying conditions are not particularly limited. Although the water may be completely removed by vacuum drying, preliminary drying may be only performed, and in the subsequent step, a high dielectric oxide dispersion liquid may be brought into contact therewith.

### [High Dielectric Oxide Solid Dispersion Liquid Preparation Step]

The high dielectric oxide solid dispersion liquid preparation step is a step of preparing a high dielectric oxide dispersion liquid including the first high dielectric oxide solid and an organic solvent. As described above, in the method for manufacturing a lithium ion secondary battery electrode according to the present invention, in the electrode paste for forming the electrode material mixture layer, water is used as the solvent. On the other hand, as a solvent for dispersing the first high dielectric oxide solid, an organic solvent is used.

### (First High Dielectric Oxide Solid)

Although the first high dielectric oxide solid used in the high dielectric oxide solid dispersion liquid preparation step is not particularly limited, the first high dielectric oxide solid can be preferably applied to the lithium ion secondary battery electrode of the present invention described above.

Since the solvent for preparing the high dielectric oxide solid dispersion liquid is not water but the organic solvent, a high dielectric oxide solid which is reactive water can be applied. Examples of the high dielectric oxide solid which is reactive water include Li₇La₃Zr₂O₁₂ (LLZO), Li₅La₃Ta₂O₁₂ (LLTO) and the like. In the method for manufacturing a lithium ion secondary battery electrode according to the present invention, even when the high dielectric oxide solid which is reactive water is used, the electrode can be produced without its activity being impaired.

### (Organic Solvent)

Although the organic solvent of the high dielectric oxide solid dispersion liquid is not particularly limited, examples thereof can include alcohols, ketones, carbonates and nitrile compounds, and in terms of reducing a reaction on the surface of the solid oxide, non-protonic solvents are preferable. Among non-protonic solvents, a solvent which can be used in the electrolytic solution of a lithium ion battery is particularly preferable because part thereof is remained to function as an electrolytic solution component.

More specifically, examples thereof can include carbonate esters. Examples of a cyclic carbonate include ethylene carbonate, vinylene carbonate, propylene carbonate, butylene carbonate and the like. A cyclic carbonate, such as trifluoropropylene carbonate or fluoroethyl carbonate, in which a part or the whole of hydrogen groups in the compound are fluorinated, may be preferably used. Examples of a chain carbonate include dimethyl carbonate, ethyl methyl carbonate, diethyl carbonate, methyl propyl carbonate, ethyl propyl carbonate, methyl isopyr carbonate and the like.

### (Preparation Conditions)

The concentration of the first high dielectric oxide solid in the high dielectric oxide solid dispersion liquid is not particularly limited, and can be selected as necessary according to conditions in the electrode material mixture layer formation step to be performed later. A method of preparing the high dielectric oxide solid dispersion liquid is not particularly limited, and a known method can be applied.

### [Electrode Material Mixture Layer Formation Step]

The electrode material mixture layer formation step is a step of bringing the high dielectric oxide dispersion liquid prepared in the high dielectric oxide solid dispersion liquid preparation step into contact with a surface opposite to the surface of the current collector side of the electrode material mixture precursor layer obtained in the electrode material mixture precursor layer formation step and then drying the organic solvent included in the high dielectric oxide solid dispersion liquid to obtain the electrode material mixture layer.

Although in the electrode material mixture layer formation step, a method of bringing the high dielectric oxide dispersion liquid obtained in the high dielectric oxide solid dispersion liquid preparation step into contact with the surface opposite to the surface of the current collector side of the electrode material mixture precursor layer is not particularly limited, at least one type selected from the group consisting of dropping, applying, spraying and impregnating is preferable.

A method of drying the organic solvent included in the high dielectric oxide solid dispersion liquid after the high dielectric oxide solid dispersion liquid is brought into contact therewith is not particularly limited, and a known method can be applied. Drying conditions are not particularly limited.

The high dielectric oxide solid dispersion liquid is brought into contact with only the surface opposite to the surface of the current collector side of the electrode material mixture precursor layer, and then the organic solvent included in the high dielectric oxide solid dispersion liquid is dried, and thus the first high dielectric oxide solid included in the high dielectric oxide solid dispersion liquid can be arranged to have a concentration gradient that is continuously or stepwise reduced from the surface opposite to the current collector toward the current collector in the direction of thickness of the electrode material mixture layer.

In the method for manufacturing a lithium ion secondary battery electrode according to the present invention, in the lithium ion secondary battery electrode which is finally obtained, the first high dielectric oxide solid is preferably arranged in a region one half or less of the thickness of the electrode material mixture layer from the surface opposite to the current collector in the direction of the thickness. The first high dielectric oxide solid is arranged in the region one half or less of the thickness therefrom, and thus variations in potential in the direction of the electrode can be sufficiently suppressed without the dielectric oxide particles being arranged to be inclined over the direction of the thickness.

### [Press Step]

The press step is a step of pressing the electrode material mixture layer obtained in the electrode material mixture layer formation step to finally obtain the lithium ion secondary battery electrode.

The electrode material mixture layer is pressed, and thus an electrode density is increased to enhance the volumetric energy density, and the first high dielectric oxide solid and the second high dielectric oxide solid which is arbitrarily added can be arranged in the gaps of the electrode active material.

By the pressing, it is easy to form a concentration gradient in which the filling density of the high dielectric oxide solid present in the current collector side of the electrode material mixture layer is lower than the filling density of the high dielectric oxide solid present around the surface opposite to the current collector of the electrode material mixture layer.

When in the electrode paste preparation step, the second high dielectric oxide solid is mixed, in the lithium ion secondary battery electrode obtained after the press step is performed, the second high dielectric oxide solid is present substantially uniformly over the entire electrode material mixture layer while the first high dielectric oxide solid is present to have a concentration gradient that is continuously or stepwise suppressed from the surface opposite to the current collector toward the current collector in the direction of thickness of the electrode material mixture layer.

A method of pressing the electrode material mixture layer is not particularly limited, and a known method can be applied. Pressing conditions are not particularly limited.

### <Method for Manufacturing Lithium Ion Secondary Battery>

A method for manufacturing a lithium ion secondary battery according to the present invention is not particularly limited as long as the lithium ion secondary battery electrode of the present invention is used as the negative electrode, and a normal method in the present technical field can be applied.

### EXAMPLES

Although the present invention will then be described in more detail based on Examples and Comparative Examples, the present invention is not limited to them.

### Example 1

### [Production of Negative Electrode]

Sodium carboxymethylcellulose (CMC) serving as a binder and acetylene black serving as a conductive aid were mixed and were dispersed with a planetary mixer, with the result that a mixture was obtained. Artificial graphite (AG, D50=12 μm) serving as a negative electrode active material was mixed with the mixture obtained, and was dispersed again with the planetary mixer, and thus a mixture for negative electrode material mixture was obtained. Then, the mixture for negative electrode material mixture obtained was dispersed in water, styrene butadiene rubber (SBR) serving as a binder was added and thus a negative electrode material mixture paste was produced such that the mass ratio was negative electrode active material:conductive aid:styrene butadiene rubber (SBR):binder (CMC)=96.5:1:1.5:1.

As a negative electrode current collector, a copper foil having a thickness of 12 μm was prepared, the produced negative electrode material mixture paste was applied to one surface of the negative electrode current collector, was dried at 100° C. for 10 minutes, was thereafter immersed in a liquid where Li₇La₃Zr₂O₁₂ (LLZO) serving as first high dielectric oxide solid particles and having an average particle diameter of 0.2 pm was dispersed in N-methyl-2-pyrrolidone (NMP) and was permeated such that the mass ratio of the LLZO to the entire negative electrode material mixture layer was 0.5 wt %. Then, the negative electrode current collector was dried at 60° C. for 10 minutes, was thereafter pressurized with a roll press at a linear pressure of 1 t/cm and was then dried in vacuum at 120° C., with the result that a lithium ion secondary battery negative electrode in which the negative electrode material mixture layer had a density of 1.5 g/cm³ was produced. The produced negative electrode was punched out to a size of 34 mm×44 mm and was used.

### [Production of Positive Electrode]

LiNi_{0.6}Co_{0.2}Mn_{0.2}O₂ (NCM622, D50=12 μm) serving as a positive electrode active material, acetylene black serving as a conductive aid and polyvinylidene fluoride (PVDF) serving as a binder were mixed such that the mass ratio of the components was positive electrode active material:conductive aid:resin binder (PVDF)=96.5:1.5:2, and were dispersed with the planetary mixer, with the result that a mixture for positive electrode material mixture was obtained. Then, the mixture for positive electrode material mixture obtained was dispersed in N-methyl-2-pyrrolidone (NMP), and thus a positive electrode material mixture paste was produced.

As a positive electrode current collector, an aluminum foil having a thickness of 12 μm was prepared, the produced positive electrode material mixture paste was applied to one surface of the positive electrode current collector, was dried at 120° C. for 10 minutes, was thereafter pressurized with a roll press at a linear pressure of 1 t/cm and was then dried in vacuum at 120° C., with the result that a lithium ion secondary battery positive electrode in which the positive electrode material mixture layer had a density of 3.3 g/cm³ was produced. The produced positive electrode was punched out to a size of 30 mm×40 mm and was used.

### [Production of Lithium Ion Secondary Battery]

As a separator, a three-layer laminate of polypropylene/polyethylene/polypropylene (thickness of 20 μm) was prepared. The positive electrode, the separator and the negative electrode produced as described above were stacked in layers and were inserted into a bag-shaped container which was obtained by thermally sealing a secondary battery aluminum laminate (made by Dai Nippon Printing Co., Ltd.).

Here, the separator was sandwiched between the positive electrode material mixture layer of the positive electrode and the negative electrode material mixture layer of the negative electrode, part of the positive electrode current collector where the positive electrode material mixture layer was not formed and part of the negative electrode current collector where the negative electrode material mixture layer was not formed were extended out of the container, an electrolytic solution was injected into the container and the container was thereafter vacuum-sealed, with the result that a lithium ion secondary battery in which an end portion of the separator was immersed in the electrolytic solution stored in a bottom portion was produced.

A solution was obtained by dissolving 1.0 mol/L of LiPF, in a solvent in which ethylene carbonate, diethyl carbonate and ethyl methyl carbonate were mixed to achieve a volume ratio of 30:30:40, and the solution obtained was used as the electrolytic solution.

In the lithium ion secondary battery of the present example, the high dielectric oxide solid was included only in the negative electrode, part of the surface of the negative electrode active material was in contact with the high dielectric oxide solid and the other parts were in contact with the electrolytic solution. The following evaluations were performed on the lithium ion secondary battery obtained. The results of the evaluations are shown in table 1.

### Example 2

A lithium ion secondary battery was produced as in Example 1 except that in the negative electrode, the particle diameter of the first high dielectric oxide solid mixed in the negative electrode material mixture layer was changed as shown in table 1.

### Examples 3 to 4

### [Production of Negative Electrode]

A negative electrode material mixture paste was produced as in Example 1 except that the mixed amount was set such that positive electrode active material:conductive aid:first dielectric particles:second dielectric particles:styrene butadiene rubber (SBR):binder (CMC)=95.3:1:0.2:1:1.5:1, and the first dielectric particles were removed. In Example 3, as the second dielectric particles, lithium triphosphate was used, and in Example 4, lithium niobate was used. As a negative electrode current collector, a copper foil having a thickness of 12 pm was prepared, the produced negative electrode material mixture paste was applied to one surface of the negative electrode current collector, was dried at 100° C. for 10 minutes, was thereafter put into a glass beaker and was dried in a decompression drying furnace at 60° C. for 24 hours. Thereafter, the negative electrode current collector was immersed in a liquid where Li₇La₃Zr₂O₁₂ (LLZO) serving as first high dielectric oxide solid particles and having an average particle diameter of 0.2 μm was dispersed in N-methyl-2-pyrrolidone (NMP) and was permeated such that the mass ratio of the LLZO to the entire negative electrode material mixture layer was 0.2 wt %. The negative electrode current collector was put into a beaker, and dropping was performed from above such that the entire electrode was wet. The negative electrode current collector was put into the decompression drying furnace, and the dispersion solution was permeated by a decompression impregnation method between active material particles inside the negative electrode material mixture. This electrode member was dried at 120° C. for 10 minutes and was thereafter pressurized with the roll press. A lithium ion secondary battery positive electrode in which the negative electrode material mixture layer had a density of 1.5 g/cm³ was produced. The produced negative electrode was punched out to a size of 34 mm×44 mm and was used.

### [Production of Positive Electrode]

A positive electrode was produced as in Example 1.

### [Production of Lithium Ion Secondary Battery]

A lithium ion secondary battery was produced as in Example 1.

### Comparative Example

### [Production of Negative Electrode]

A negative electrode material mixture paste was produced as in Example 1. As a negative electrode current collector, a copper foil having a thickness of 12 μm was prepared, the produced negative electrode material mixture paste was applied to one surface of the negative electrode current collector, was dried at 100° C. for 10 minutes, was thereafter pressurized with the roll press at a linear pressure of 1 t/cm without being immersed in the dispersion liquid where the high dielectric oxide solid particles are dispersed and was then dried in vacuum at 120° C., with the result that a lithium ion secondary battery negative electrode in which the negative electrode material mixture layer had a density of 1.5 g/cm³ was produced. The produced negative electrode was punched out to a size of 34 mm×44 mm and was used.

### [Production of Positive Electrode]

A positive electrode was produced as in Example 1.

### [Production of Lithium Ion Secondary Battery]

A lithium ion secondary battery was produced as in Example 1.

### <Evaluations>

The following evaluations were performed on the lithium ion secondary batteries obtained in Examples 1 to 4 and Comparative Example 1. The results of the evaluations are shown in table 1.

### [Observation of Arrangement of First High Dielectric Oxide Solid (SEM Observation)]

A cross section of the electrode material mixture layer was produced by an ion milling method to be observed by SEM so that the state of the dispersion of the first high dielectric oxide solid in the produced lithium ion secondary battery electrode was checked.

As the shooting range of a cross-sectional SEM, a range of 100% in the direction of thickness of the electrode material mixture layer (up/down direction) was selected. A shooting magnification was set to about 5000 to 10000 times, an image was divided and shot as a plurality of images and thus the state of the arrangement of the LLZO serving as the first high dielectric oxide solid was checked.

In the lithium ion secondary battery negative electrodes produced in Examples 1 to 4, the thickness of the mixture layer was 77 μm, and the fine particles of the LLZO were concentrated in an upper layer which is to be the separator side (the side opposite to the current collector). It was confirmed that particles other than the LLZO were present up to a depth of 38 μm which was about one half of the thickness from the surface layer of the separator side of the mixture layer (the side opposite to the current collector).

Assuming that the thickness of the electrode material mixture layer was 100, up to 25%, of the thickness from the surface layer of the separator side (the side opposite to the current collector) in the direction of the depth was a region A and 25 to 50% of the thickness in the direction of the depth was a region B, a ratio (A:B) of the LLZO present in the region A and the LLZO present in the region B was determined as a concentration gradient in the arrangement of the first high dielectric oxide solid. Binarization processing was performed on a reflected electron image of the cross-sectional SEM, a graph of a brightness distribution curve was produced and thus the ratio of A:B was calculated from a ratio of the area of the LLZO in the region A and the area of the LLZO in the region B.

### [Initial Discharge Capacity]

The lithium ion secondary battery obtained was left to stand at a measurement temperature (25° C.) for 1 hour, was subjected to constant current charge at 0.33 C up to 4.2 V, was then subjected to constant voltage charge at a voltage of 4.2 V for 1 hour, was left to stand for 30 minutes and was discharged at a discharge rate of 0.2 C up to 2.5 V, with the result that the discharge capacity was measured.

### [Initial Cell Resistance]

The lithium ion secondary battery after the measurement of the initial discharge capacity was adjusted to a charge level (SOC (State of Charge)) of 50%. Then, pulse discharge was performed for 10 seconds with the C rate set to 0.2 C, and a voltage when discharge was performed for 10 seconds was measured. Then, with the horizontal axis set to a current value and the vertical axis set to a voltage, a voltage when discharge was performed for 10 seconds with respect to the current at 0.2 C was plotted. Then, the lithium ion secondary battery was left to stand for 5 minutes, was thereafter subjected to replenishing charge to return the SOC to 50% and was then further left to stand for 5 minutes.

Then, the operation described above was performed at each of C rates of 0.5 C, 1 C, 2 C, 3 C and 4 C, and a voltage when discharge was performed for 10 seconds with respect to the current at each C rate was plotted. Then, the slope of an approximate straight line obtained from the plots was assumed to be the initial cell resistance of the lithium ion secondary battery.

### [Discharge Capacity After Durability]

As a charge/discharge cycle durability test, an operation of performing constant current charge at 1.0 C up to 4.2 V in a constant temperature chamber at 45° C. and then performing constant current discharge at a discharge rate of 1.5 C up to 2.5 V was assumed to be one cycle, and the operation was repeated for 500 cycles. After the completion of 500 cycles, the constant temperature chamber was set to 25° C., the lithium ion secondary battery was left to stand for 24 hours in a state after discharge of 2.5 V and thereafter as in the measurement of the initial discharge capacity, the discharge capacity after durability was measured.

### [Cell Resistance After Durability]

The lithium ion secondary battery after the measurement of the discharge capacity after durability was adjusted to a charge level (SOC (State of Charge)) of 50%, and a cell resistance after durability was measured by the same method as in the measurement of the initial cell resistance.

### [Capacity Retention Rate]

The discharge capacity after durability with respect to the initial discharge capacity was determined and was assumed to be a capacity retention rate.

### [Cell Resistance Increase Rate]

The cell resistance after durability with respect to the initial cell resistance was determined and was assumed to be a cell resistance increase rate.

TABLE 1

| | | | | | | Comparative |
|---|---|---|---|---|---|---|
| | | Example 1 | Example 2 | Example 3 | Example 4 | Example 1 |
| Negative | Negative electrode active | Artificial | Same as in | Same as in | Same as in | Same as in |
| electrode | material | graphite | Example 1 | Example 1 | Example 1 | Example 1 |
| | Density of negative electrode | 1.5 | 1.5 | 1.5 | 1.5 | 1.5 |
| | mixture layer (g/cm³) | | | | | |
| | First high dielectric oxide | LLZO | LLZO | LLZO | LLZO | — |
| | solid | | | | | |
| | Powder relative permittivity | 48 | 48 | 48 | 48 | — |
| | Particle diameter D50 (μm) | 0.2 | 0.4 | 0.2 | 0.2 | — |
| | Mass ratio (wt %) | 0.5 | 0.5 | 0.3 | 0.3 | — |
| | Arrangement status (A:B) | 81:19 | 81:19 | 87:13 | 87:13 | 0:0 |
| | Second high dielectric oxide | — | — | Li3PO4 | LiNbO2 | — |
| | solid | | | | | |
| | Powder relative permittivity | — | — | 48 | 201 | — |
| | Particle diameter D50 (μm) | — | — | 0.4 | 0.4 | — |
| | Mass ratio (wt %) | — | — | 1 | 1 | — |
| Positive | Positive electrode active | NCM622 | Same as in | Same as in | Same as in | Same as in |
| electrode | material | | Example 1 | Example 1 | Example 1 | Example 1 |
| | Density of positive electrode | 3.3 | Same as in | Same as in | Same as in | Same as in |
| | material mixture layer | | Example 1 | Example 1 | Example 1 | Example 1 |
| | (g/cm³) | | | | | |
| Initial | Discharge capacity (mAh) | 40.2 | 40.2 | 39.8 | 39.8 | 40.6 |
| performance | Initial cell resistance | 1.05 | 1.05 | 1.08 | 1.08 | 1.00 |
| | Ω@SOC50% | | | | | |
| Durability | Discharge capacity after | 35.4 | 35.8 | 36.2 | 36.4 | 32.9 |
| performance | durability (mAh) | | | | | |
| | Cell resistance after | 1.42 | 1.42 | 1.43 | 1.43 | 1.43 |
| | durability Ω@SOC50% | | | | | |

| | | | | | |
|---|---|---|---|---|---|
| Capacity retention rate (%) | 88.0 | 89.0 | 91.0 | 91.5 | 81.0 |
| Cell resistance increase rate (%) | 135.0 | 135.0 | 132.0 | 132.0 | 143.0 |

### EXPLANATION OF REFERENCE NUMERALS

1 Lithium ion secondary battery

2 Positive electrode current collector

3 Positive electrode material mixture layer

4 Positive electrode

5 Negative electrode current collector

6 Negative electrode material mixture layer

7 Negative electrode

8 Separator

9 Electrolytic solution

10 Container

1. A lithium ion secondary battery electrode comprising an electrolytic solution, the electrode comprising;
a current collector; and an electrode material mixture layer stacked on the current collector,
wherein the electrode material mixture layer comprises an electrode active material and a first high dielectric oxide solid, and
in the electrode material mixture layer, the first high dielectric oxide solid is arranged to have a concentration gradient that is continuously or stepwise reduced from a surface opposite to the current collector toward the current collector in a direction of thickness of the electrode material mixture layer.

2. The lithium ion secondary battery electrode according to claim 1, wherein the first high dielectric oxide solid is arranged in gaps of the electrode active material.

3. The lithium ion secondary battery electrode according to claim 1, wherein in the electrode material mixture layer, the first high dielectric oxide solid is arranged in a region one half or less of the thickness in the direction of the thickness from the surface opposite to the current collector.

4. The lithium ion secondary battery electrode according to claim 1, wherein the first high dielectric oxide solid is an oxide solid electrolyte.

5. The lithium ion secondary battery electrode according to claim 1, wherein the lithium ion secondary battery electrode is a negative electrode.

6. The lithium ion secondary battery electrode according to claim 1, wherein the first high dielectric oxide solid is a reduction decomposition-resistant lithium ion conductive solid electrolyte.

7. The lithium ion secondary battery electrode according to claim 6, wherein the reduction decomposition-resistant lithium ion conductive solid electrolyte has a reduction decomposition potential that is lower than a Li/Li⁺ equilibrium potential by 1.5 V (1.5 V vs Li/Li⁺) or less,

8. The lithium ion secondary battery electrode according to claim 6, wherein the reduction decomposition-resistant lithium ion conductive solid electrolyte is at least one or more types selected from the group consisting of Li₇La₃Zr₂O₁₂, Li₅La₃Ta₂O₂, LiNbO₃, Li₃PO₄ and Li_{2.9}PO_{3.3}N_{0.46}.

9. The lithium ion secondary battery electrode according to claim 1, wherein the electrode material mixture layer further comprises a second high dielectric oxide solid.

10. The lithium ion secondary battery electrode according to claim 9, wherein the second high dielectric oxide solid is arranged in the gaps of the electrode active material.

11. The lithium ion secondary battery electrode according to claim 9, wherein the second high dielectric oxide solid is arranged substantially uniformly over the entirety of the electrode material mixture layer.

12. A lithium ion secondary battery comprising: a positive electrode; a negative electrode; a separator that electrically insulates the positive electrode and the negative electrode; and an electrolytic solution,
wherein the negative electrode is the lithium ion secondary battery electrode according to claim 1.

13. The lithium ion secondary battery according to claim 12, further comprising: a container that houses the positive electrode, the negative electrode, the separator and the electrolytic solution,
wherein the separator is in contact with the electrolytic solution stored in the container.

14. A. method for manufacturing a lithium ion secondary battery electrode comprising a current collector and an electrode material mixture layer stacked on the current collector, the method comprising:
an electrode paste preparation step of preparing an electrode paste comprising an electrode active material and water;
an electrode material mixture precursor layer formation step of applying the electrode paste on the current collector and drying the water to obtain an electrode material mixture precursor layer;
a high dielectric oxide solid dispersion liquid preparation step of preparing a high dielectric oxide dispersion liquid comprising a first high dielectric oxide solid and an organic solvent;
an electrode material mixture layer formation step of bringing the high dielectric oxide dispersion liquid into contact with a surface opposite to a surface of the current collector side of the electrode material mixture precursor layer and drying the organic solvent to obtain the electrode material mixture layer; and
a press step of pressing the electrode material mixture layer to obtain the lithium ion secondary battery electrode.

15. The method for manufacturing a lithium ion secondary battery electrode according to claim 14, wherein a method for the bringing of the high dielectric oxide dispersion liquid into contact in the electrode material mixture layer formation step is at least one type selected from the group consisting of dropping, applying, spraying and impregnating.

16. The method for manufacturing a lithium ion secondary battery electrode according to claim 14, wherein in the electrode material mixture layer formation step, the first high dielectric oxide solid is arranged to have a concentration gradient that is continuously or stepwise reduced from a surface opposite to the current collector toward the current collector in a direction of thickness of the electrode material mixture layer.

17. The method for manufacturing a lithium ion secondary battery electrode according to claim 14, wherein the electrode paste further comprises a second high dielectric oxide solid.

18. The method for manufacturing a lithium ion secondary battery electrode according to claim 14, wherein the lithium ion secondary battery electrode is a negative electrode.
